(19) United States
(12) Patent Application Publication
(10) Pub. No.: US 2011/0267463 A1
(43) Pub. Date: Nov. 3, 2011

(54) IMAGE CAPTURING DEVICE AND METHOD FOR CONTROLLING IMAGE CAPTURING DEVICE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/860,921

(22) Filed: Aug. 22, 2010

(30) Foreign Application Priority Data
Apr. 29, 2010 (TW) 99113680

(51) Int. Cl. H04N 7/18

(52) U.S. Cl. 348/143; 348/E07.085

(57) ABSTRACT

A method for controlling an image capturing device captures a plurality of images of a monitored scene by a lens of the image capturing device, detects a pedestrian in the monitored scene, and detects if a human face is in the pedestrian. The method further adjusts the lens according to movement data of the human face if the human face is detected, or adjusts the lens according to movement data of the pedestrian if no human face is detected.

### BACKGROUND

1. Technical Field

Embodiments of the present disclosure relate to security surveillance technology, and particularly to an image capturing device and method for controlling the image capturing device.

2. Description of Related Art

Currently, image capturing devices have been used to perform security surveillance by capturing images of monitored scenes, and sending the captured images to a monitoring computer. However, a position of a lens of the image capturing device cannot be changed according to movements of an object in the monitored scene. Therefore, an efficient method for adjusting a position of the lens of the image capturing device is desired.

### BRIEF DESCRIPTION OF THE DRAWINGS

FIG. 1 is a block diagram of one embodiment of an image capturing device.

FIG. 2 is a schematic diagram of one embodiment of images captured by the image capturing device if a human face is detected.

FIG. 3 is a schematic diagram of one embodiment of images captured by the image capturing device if a human face is not detected.

FIG. 4 is a flowchart of one embodiment of a method for controlling the image capturing device.

### DETAILED DESCRIPTION

All of the processes described below may be embodied in, and fully automated by, functional code modules executed by one or more general purpose computers or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, or a tape drive.

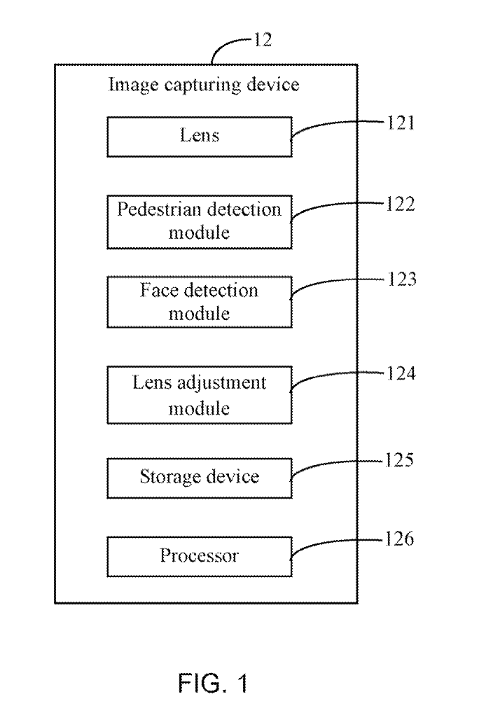

FIG. 1 is a block diagram of one embodiment of an image capturing device 12. In one embodiment, the image capturing device 12 includes a lens 121, a pedestrian detection module 122, a face detection module 123, a lens adjustment module 124, a storage device 125, and a processor 126. In one embodiment, the modules 122-124 comprise one or more computerized instructions that are stored in the storage device 125. The processor 126 executes the computerized instructions to implement one or more operations of the image capturing device 12. In one embodiment, the image capturing device 12 may be a speed dome camera or pan/tilt/zoom (PTZ) camera, for example. The image capturing device 12 may be used to adjust a position of the lens 121 when a pedestrian is detected in a monitored scene. A detailed description will be given in the following paragraphs.

The lens 121 captures a plurality of images of the monitored scene. In one embodiment, the lens 121 may be a charge coupled device (CCD). The monitored scene may be a warehouse or other important location.

The pedestrian detection module 122 detects a pedestrian in the monitored scene from the captured images. In one embodiment, the pedestrian detection module 122 detects the pedestrian in the monitored scene using a pedestrian detection technology, and the pedestrian detection technology may be the AdaBoost algorithm.

Under the condition that the pedestrian is detected in the monitored scene, the face detection module 123 detects a human face of the pedestrian from the captured images. In one embodiment, the face detection module 123 detects the face using a skin color model in YCbCr space or a face template matching technology.

If no face is detected in the monitored scene from the captured images, the lens adjustment module 124 obtains movement data of the lens 121 according to movement data of the pedestrian.

If the face is detected in the monitored scene from the captured images, the lens adjustment module 124 obtains movement data of the lens 121 according to movement data of the human face. In one embodiment, the movement data of the lens 121 may include, but is not limited to, a movement direction, a movement angle, and a movement distance. For example, the lens adjustment module 124 determines that the movement direction of the lens 121 is to the left if the movement direction of human face is to the left, or determines that the movement direction of the lens 121 is to the right if the movement direction of the human face is to the right.

The lens adjustment module 124 adjusts the position of the lens 121 according to the movement data of the lens 121. A detailed description is provided as follows.

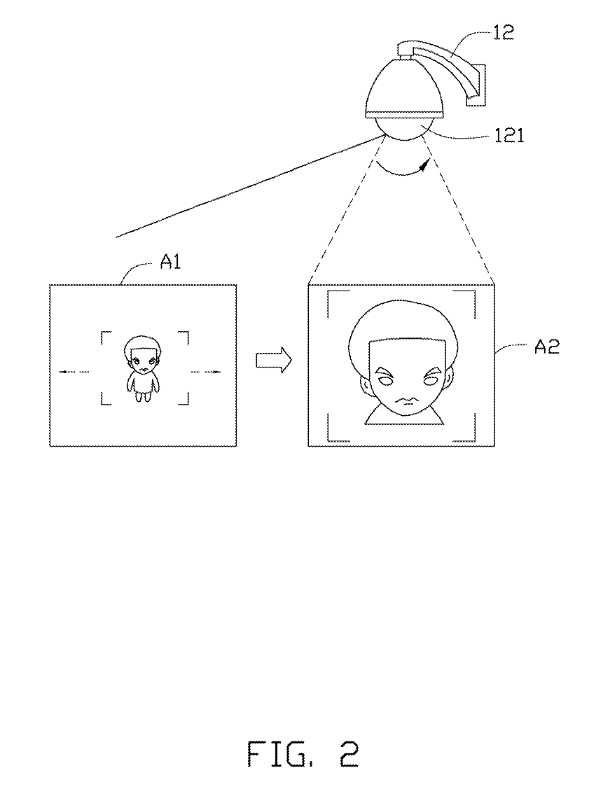

If the face is detected from the captured images, the lens adjustment module 124 pans and/or tilts the lens 121 according to the movement data of the face to focus the lens 121 on the face, and zooms in a focal length of the lens 121. Referring to FIG. 2, “Al” represents an image of the monitored scene captured by the lens 121 when a pedestrian and a human face are both detected from the captured images. “A2” represents an image of the monitored scene captured by the lens 121 when the lens 121 is adjusted according to the movement data of the face of the pedestrian.

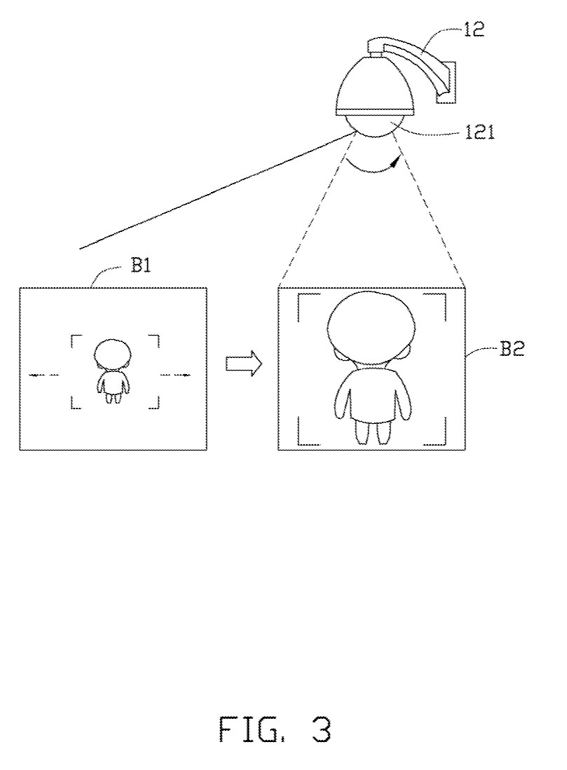

If no face is detected from the captured images, the lens adjustment module 124 pans and/or tilts the lens 121 according to the movement data of the pedestrian to focus the lens 121 on the pedestrian, and zooms in the focal length of the lens 121. Referring to FIG. 3, “B1” represents an image of the monitored scene captured by the lens 121 when a pedestrian is detected from the captured images, but a face of the pedestrian is not detected. “B2” represents an image of the monitored scene captured by the lens 121 when the lens 121 is adjusted according to the movement data of the pedestrian.

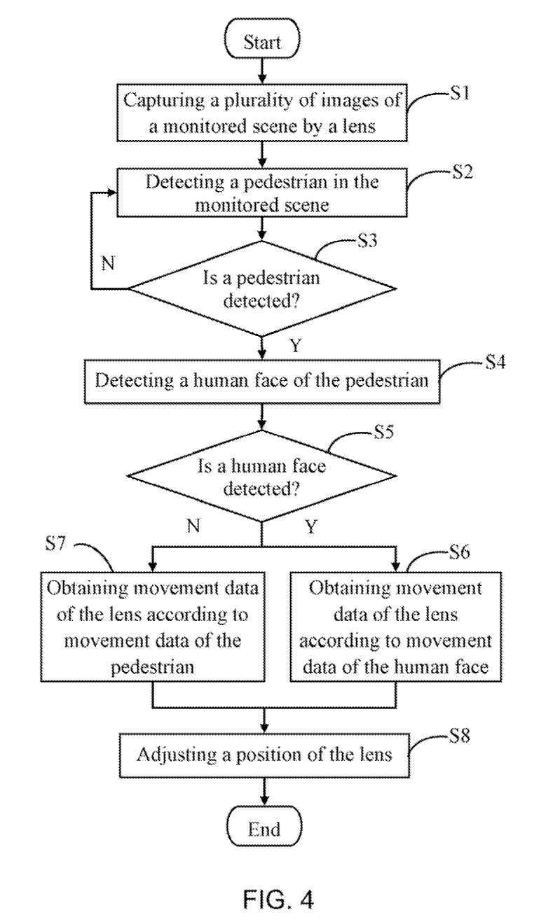

FIG. 4 is a flowchart of one embodiment of a method for controlling the image capturing device 12. Depending on the embodiment, additional blocks may be added, others removed, and the ordering of the blocks may be changed.

In block S1, the lens 121 captures a plurality of images of a monitored scene.

In block S2, the pedestrian detection module 122 detects a pedestrian in the monitored scene from the captured images.

In block S3, the pedestrian detection module 122 determines if a pedestrian is detected in the monitored scene from the captured images. If a pedestrian is detected in the monitored scene from the captured images, the procedure goes to block S4. If no pedestrian is detected in the monitored scene from the captured images, the procedure returns to block S2.

In block S4, the face detection module 123 detects a face of the pedestrian from captured images. In one embodiment, the face detection module 123 detects a face using a skin color model in YCbCr space or a human face template matching technology.

In block S5, the face detection module 123 determines if a face is detected from the captured images. If the face is detected from the captured images, the procedure goes to block S6. If no face is detected from the captured images, the procedure goes to block S7.

In block S6, the lens adjustment module 124 obtains movement data of the lens 121 according to movement data of the face. In one embodiment, the movement data of the face may include a movement direction, a movement angle, and a movement distance.

In block S7, the lens adjustment module 124 obtains movement data of the lens 121 according to movement data of the pedestrian.

In block S8, the lens adjustment module 124 adjusts a position of the lens 121 according to the movement data of the lens 121. If the face is detected from the captured images, the lens adjustment module 124 pans and/or tilts the lens 121 according to the movement data of the face to focus the lens 121 on the face, and zooms in a focal length of the lens 121. If no face is detected from the captured images, the lens adjustment module 124 pans and/or tilts the lens 121 according to the movement data of the pedestrian to focus the lens 121 on the pedestrian, and zooms in the focal length of the lens 121.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. An image capturing device, comprising:
a lens operable to captured a plurality of images of a monitored scene;
a pedestrian detection module operable to detect a pedestrian in the monitored scene from the captured images;
a face detection module operable to detect a human face of the pedestrian from the captured images; and
a lens adjustment module operable to control the lens according to movement data of the human face under the condition that the human face is detected from the captured images, or control the lens according to movement data of the pedestrian under the condition that no human face is detected from the captured images.

2. The image capturing device according to claim 1, wherein the lens is a charge coupled device.

3. The image capturing device according to claim 1, wherein the pedestrian detection module detects the pedestrian in the monitored scene using a pedestrian detection technology.

4. The image capturing device according to claim 1, wherein the movement data of the human face or the pedestrian comprises a movement direction, a movement angle, and a movement distance.

5. The image capturing device according to claim 4, wherein the lens adjustment module controls the lens according to movement data of the human face by panning and/or tilting the lens according to the movement data of the human face to focus the lens on the human face, and zooming in a focal length of the lens; or
controls the lens according to movement data of the pedestrian by panning and/or tilting the lens according to the movement data of the pedestrian to focus the lens on the pedestrian, and zooming in the focal length of the lens.

6. A method for controlling an image capturing device, comprising:
capturing a plurality of images of a monitored scene by the lens;
detecting a pedestrian in the monitored scene from the captured images;
detecting if a human face is of the pedestrian from the captured images; and
controlling the lens according to movement data of the human face under the condition that the human face is detected from the captured images, or controlling the lens according to movement data of the pedestrian under the condition that no human face is detected from the captured images.

7. The method according to claim 6, wherein the lens is a charge coupled device.

8. The method according to claim 6, wherein the pedestrian in the monitored scene is detected using a pedestrian detection technology.

9. The method according to claim 6, wherein the movement data of the human face or the pedestrian comprises a movement direction, a movement angle, and a movement distance.

10. The method according to claim 9, wherein the step of controlling the lens according to movement data of the human face under the condition that the human face is detected from the captured images, or controlling the lens according to movement data of the pedestrian under the condition that no human face is detected from the captured images comprises:
panning and/or tilting the lens according to the movement data of the human face to focus the lens on the human face if the human face is detected from the captured images, and zooming in a focal length of the lens; or
panning and/or tilting the lens according to the movement data of the pedestrian to focus the lens on the pedestrian under the condition that no human face is detected from the captured images, and zooming in the focal length of the lens.

11. A non-transitory storage medium having stored thereon instructions that, when executed by a processor of an image capturing device, causes the processor to perform a method for controlling the image capturing device, the method comprising:
capturing a plurality of images of a monitored scene by the lens;
detecting a pedestrian in the monitored scene from the captured images;
detecting if a human face is of the pedestrian from the captured images; and
controlling the lens according to movement data of the human face under the condition that the human face is detected from the captured images, or controlling the lens according to movement data of the pedestrian under the condition that no human face is detected from the captured images.

12. The non-transitory storage medium according to claim 11, wherein the lens is a charge coupled device.

13. The non-transitory storage medium according to claim 11, wherein the pedestrian in the monitored scene is detected using a pedestrian detection technology.

14. The non-transitory storage medium according to claim 11, wherein the movement data of the human face or the pedestrian comprises a movement direction, a movement angle, and a movement distance.

15. The non-transitory storage medium according to claim 14, wherein the step of controlling the lens according to movement data of the human face under the condition that the human face is detected from the captured images, or controlling the lens according to movement data of the pedestrian under the condition that no human face is detected from the captured images comprises:
panning and/or tilting the lens according to the movement data of the human face to focus the lens on the human face if the human face is detected from the captured images, and zooming in a focal length of the lens; or
panning and/or tilting the lens according to the movement data of the pedestrian to focus the lens on the pedestrian under the condition that no human face is detected from the captured images, and zooming in the focal length of the lens.
